(19) United States
(12) Patent Application Publication
(10) Pub. No.: US 2023/0188189 A1
(43) Pub. Date: Jun. 15, 2023

(54) METHODS FOR SUPPORTING MULTIPLE BEAMS IN CRI FOR GENERATION OF ADAPTIVE BEAM WEIGHTS

(71) Applicant: QUALCOMM Incorporated, San Diego, CA (US)

(72) Inventors: Vasanthan Raghavan, West Windsor Township, NJ (US); Yan Zhou, San Diego, CA (US); Tao Luo, San Diego, CA (US); Junyi Li, Fairless Hills, PA (US)

(21) Appl. No.: 17/551,014

(22) Filed: Dec. 14, 2021

(51) Int. Cl. H04B 7/06; H04B 17/318

(52) U.S. Cl. CPC H04B 7/0626; H04B 7/0617; H04B 17/318

(57) ABSTRACT

Methods, systems, and devices for wireless communications are described. Some wireless communications systems may support dynamic beamforming and beam reporting. In some cases, a base station may transmit an indication to a user equipment (UE) that a channel state information reference signal (CSI-RS) resource indicator (CRI) used to report a selected beam is associated with two or more beams. The UE may then monitor a downlink burst from the bases station, the downlink burst having one or more CSI-RSs for measurement by the UE in accordance with the CRI. Based on performing measurements on the CSI-RSs, the UE may generate and transmit one or more CSI reports to the base station, and the UE may receive a downlink transmission from the base station over a weighted combination of the two or more beams.

### FIELD OF TECHNOLOGY

The following relates to wireless communications, including methods for supporting multiple beams in channel state information-reference signal (CSI-RS) resource indicator (CRI) for generation of adaptive beam weights to be used in analog/hybrid beamforming.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Wireless communications systems may implement a number of different beam measurement and beam reporting techniques. Some such techniques, however, may be inefficient in adapting to changing channel conditions.

### SUMMARY

The described techniques relate to improved methods, systems, devices, and apparatuses that support methods for supporting multiple beams in channel state information-reference signal (CSI-RS) resource indicator (CRI) for generation of adaptive beam weights in analog/hybrid beamforming. Generally, the described techniques provide support for dynamic beamforming processes over one radio frequency (RF) chain corresponding to analog beamforming or over many RF chains corresponding to hybrid beamforming. In some wireless communications systems, devices may use dynamic beam weights to alter the magnitude and phase of a wavefront or signal transmitted over multiple antenna elements, which allows for the signaling energy to be split across multiple directions or combined into a single beam. For example, in dynamic beamforming procedures, a base station, user equipment (UE), or both, may dynamically adjust antenna phases and/or amplitudes to account for various channel conditions.

To support dynamic beamforming and beam refinement, the base station may then generate a refined beam using a linear combination of static beams across predetermined directions which are weighted appropriately. In some cases, the UE may indicate a single selected beam or beam pair with the highest signal strength using a CRI. In some other cases, the base station may transmit an indication that the CRI may be associated with two or more beams, and the UE may report multiple CSI reports for multiple beams per CRI. For example, the base station may configure the UE to report multiple selected beams per CRI (e.g., N beams per CRI). In some other examples, the UE may select the top one or more clusters in the channel with the highest signal strength to report per CRI.

A method for wireless communication at a UE is described. The method may include receiving, from a base station, an indication that a CRI is associated with two or more beams, monitoring, from the base station, a downlink burst including one or more CSI-RSs for measurement by the UE in accordance with the CRI, and transmitting, to the base station, one or more CSI reports for the two or more beams based on the measurement.

An apparatus for wireless communication at a UE is described. The apparatus may include a processor, memory coupled with the processor, and instructions stored in the memory. The instructions may be executable by the processor to cause the apparatus to receive, from a base station, an indication that a CSI-RS resource indicator is associated with two or more beams, monitor, from the base station, a downlink burst including one or more CSI-RSs for measurement by the UE in accordance with the CRI, and transmit, to the base station, one or more CSI reports for the two or more beams based on the measurement.

Another apparatus for wireless communication at a UE is described. The apparatus may include means for receiving, from a base station, an indication that a CSI-RS resource indicator is associated with two or more beams, means for monitoring, from the base station, a downlink burst including one or more CSI-RSs for measurement by the UE in accordance with the CRI, and means for transmitting, to the base station, one or more CSI reports for the two or more beams based on the measurement.

A non-transitory computer-readable medium storing code for wireless communication at a UE is described. The code may include instructions executable by a processor to receive, from a base station, an indication that a CSI-RS resource indicator is associated with two or more beams, monitor, from the base station, a downlink burst including one or more CSI-RSs for measurement by the UE in accordance with the CRI, and transmit, to the base station, one or more CSI reports for the two or more beams based on the measurement.

Some examples of the method, apparatuses, and non-transitory computer-readable medium described herein may further include operations, features, means, or instructions for receiving, from the base station, a downlink transmission over a weighted combination of the two or more beams in accordance with the one or more CSI reports.

In some examples of the method, apparatuses, and non-transitory computer-readable medium described herein, the monitoring may include operations, features, means, or instructions for measuring a RSRP for each of the two or more beams indicated by the CRI and transmitting, to the base station, the one or more CSI reports including the measured RSRP for the two or more beams.

Some examples of the method, apparatuses, and non-transitory computer-readable medium described herein may further include operations, features, means, or instructions for selecting the two or more beams based on a threshold RSRP for measurements of the one or more CSI-RSs and transmitting, to the base station, an indication of the two or more beams associated with the CRI, the two or more beams having a RSRP that exceeds the threshold.

In some examples of the method, apparatuses, and non-transitory computer-readable medium described herein, the two or more beams include a total number of beams in a channel having a RSRP that exceeds the threshold.

Some examples of the method, apparatuses, and non-transitory computer-readable medium described herein may further include operations, features, means, or instructions for receiving, from the base station, a set of transmission configuration indicator (TCI) states associated with the two or more beams and selecting the two or more beams based on the set of TCI states.

In some examples of the method, apparatuses, and non-transitory computer-readable medium described herein, each TCI state of the set of TCI states may be associated with a beam weight, a set of beam weights, a beam weight set index, or any combination thereof.

Some examples of the method, apparatuses, and non-transitory computer-readable medium described herein may further include operations, features, means, or instructions for receiving, from the base station, an indication of a set of TCI states and a repetition factor associated with the one or more CSI-RSs, receiving, from the base station, one or more repetitions of the one or more CSI-RSs in accordance with the repetition factor, and determining a beam weight factor to be used in analog beamforming, hybrid beamforming, or both, based on the one or more repetitions of the one or more CSI-RSs.

Some examples of the method, apparatuses, and non-transitory computer-readable medium described herein may further include operations, features, means, or instructions for determining the beam weight factor based on a weighted combination of a set of beam weight vectors associated with the one or more repetitions of the one or more CSI-RSs.

Some examples of the method, apparatuses, and non-transitory computer-readable medium described herein may further include operations, features, means, or instructions for receiving, from the base station, an indication that the UE may be to perform a full beam sweep or a partial beam sweep across beams of the indicated set of TCI states and determining the beam weight factor based on a weighted combination of beam weights of the full beam sweep or the partial beam sweep.

In some examples of the method, apparatuses, and non-transitory computer-readable medium described herein, the two or more beams include a different number of beams for different CRIs.

A method for wireless communication at a base station is described. The method may include transmitting, to a UE, an indication that a CSI-RS resource indicator is associated with two or more beams, transmitting, to the UE, a downlink burst including one or more CSI-RSs for measurement by the UE in accordance with the CRI, and receiving, from the UE, one or more CSI reports for the two or more beams based on the measurement.

An apparatus for wireless communication at a base station is described. The apparatus may include a processor, memory coupled with the processor, and instructions stored in the memory. The instructions may be executable by the processor to cause the apparatus to transmit, to a UE, an indication that a CSI-RS resource indicator is associated with two or more beams, transmit, to the UE, a downlink burst including one or more CSI-RSs for measurement by the UE in accordance with the CRI, and receive, from the UE, one or more CSI reports for the two or more beams based on the measurement.

Another apparatus for wireless communication at a base station is described. The apparatus may include means for transmitting, to a UE, an indication that a CSI-RS resource indicator is associated with two or more beams, means for transmitting, to the UE, a downlink burst including one or more CSI-RSs for measurement by the UE in accordance with the CRI, and means for receiving, from the UE, one or more CSI reports for the two or more beams based on the measurement.

A non-transitory computer-readable medium storing code for wireless communication at a base station is described. The code may include instructions executable by a processor to transmit, to a UE, an indication that a CSI-RS resource indicator is associated with two or more beams, transmit, to the UE, a downlink burst including one or more CSI-RSs for measurement by the UE in accordance with the CRI, and receive, from the UE, one or more CSI reports for the two or more beams based on the measurement.

Some examples of the method, apparatuses, and non-transitory computer-readable medium described herein may further include operations, features, means, or instructions for transmitting, to the UE, a downlink transmission over a weighted combination of the two or more beams in accordance with the one or more CSI reports.

In some examples of the method, apparatuses, and non-transitory computer-readable medium described herein, the monitoring may include operations, features, means, or instructions for receiving, from the UE, the one or more CSI reports including a measured RSRP for each of the two or more beams indicated by the CRI.

Some examples of the method, apparatuses, and non-transitory computer-readable medium described herein may further include operations, features, means, or instructions for receiving, from the UE, an indication of the two or more beams associated with the CRI, the two or more beams having a RSRP that exceeds a threshold RSRP for measurements of the one or more CSI-RSs.

In some examples of the method, apparatuses, and non-transitory computer-readable medium described herein, the two or more beams include a total number of beams in a channel having a RSRP that exceeds the threshold.

Some examples of the method, apparatuses, and non-transitory computer-readable medium described herein may further include operations, features, means, or instructions for transmitting, to the UE, a set of TCI states associated with the two or more beams.

In some examples of the method, apparatuses, and non-transitory computer-readable medium described herein, each TCI state of the set of TCI states may be associated with a beam weight, a set of beam weights, a beam weight set index, or any combination thereof.

Some examples of the method, apparatuses, and non-transitory computer-readable medium described herein may further include operations, features, means, or instructions for transmitting, to the UE, a selection of the two or more beams based on one or more different CSI reports received from at least one other UE.

Some examples of the method, apparatuses, and non-transitory computer-readable medium described herein may further include operations, features, means, or instructions for transmitting, to the UE, an indication of a set of TCI states and a repetition factor associated with the one or more CSI-RSs, transmitting, to the UE, one or more repetitions of the one or more CSI-RSs in accordance with the repetition factor, and receiving, from the UE, a beam having a beam weight factor based on the one or more repetitions of the one or more CSI-RSs.

In some examples of the method, apparatuses, and non-transitory computer-readable medium described herein, the beam weight factor may be based on a weighted combination of a set of beam weight vectors associated with the one or more repetitions of the one or more CSI-RSs.

Some examples of the method, apparatuses, and non-transitory computer-readable medium described herein may further include operations, features, means, or instructions for transmitting, to the UE, an indication that the UE may be to perform a full beam sweep or a partial beam sweep across beams of the indicated set of TCI states.

In some examples of the method, apparatuses, and non-transitory computer-readable medium described herein, the two or more beams include a different number of beams for different CRIs.

### BRIEF DESCRIPTION OF THE DRAWINGS

FIGS. 1 and 2 illustrates example wireless communications systems that support methods for supporting multiple beams in channel state information-reference signal (CSI-RS) resource indicator (CRI) for generation of adaptive beam weights in accordance with aspects of the present disclosure.

FIG. 3 illustrates an example of a process flow that supports methods for supporting multiple beams in CRI for generation of adaptive beam weights in accordance with aspects of the present disclosure.

FIGS. 4 and 5 show block diagrams of devices that support methods for supporting multiple beams in CRI for generation of adaptive beam weights in accordance with aspects of the present disclosure.

FIG. 6 shows a block diagram of a communications manager that supports methods for supporting multiple beams in CRI for generation of adaptive beam weights in accordance with aspects of the present disclosure.

FIG. 7 shows a diagram of a system including a device that supports methods for supporting multiple beams in CRI for generation of adaptive beam weights in accordance with aspects of the present disclosure.

FIGS. 8 and 9 show block diagrams of devices that support methods for supporting multiple beams in CRI for generation of adaptive beam weights in accordance with aspects of the present disclosure.

FIG. 10 shows a block diagram of a communications manager that supports methods for supporting multiple beams in CRI for generation of adaptive beam weights in accordance with aspects of the present disclosure.

FIG. 11 shows a diagram of a system including a device that supports methods for supporting multiple beams in CRI for generation of adaptive beam weights in accordance with aspects of the present disclosure.

FIGS. 12 through 17 show flowcharts illustrating methods that support methods for supporting multiple beams in CRI for generation of adaptive beam weights in accordance with aspects of the present disclosure.

### DETAILED DESCRIPTION

Some wireless communications systems may support codebook-based beamforming processes to establish communication links between devices over one or more radio frequency (RF) chains. For example, in some static beamforming methods, devices may use different beam weights to alter the magnitude and phase of a wave-front or signal generated in an array of multiple antennas, and such changes to the beam weights may steer the wave-front or signal in a pre-determined direction of a selected static beam or beam pair.

To increase the flexibility and robustness of static beamforming methods, in some implementations, devices may support dynamic beamforming using dynamic beam weights, which allows for the signaling energy to be split between multiple beams. During dynamic beamforming, devices such as a base station or a user equipment (UE) may dynamically adjust antenna phases and/or amplitudes to account for various channel conditions. For example, the devices may assess channel statistics and conditions to determine beam weights to apply, or devices may combine beam weights to dynamically change the direction of a transmitted beam.

During a beamforming procedure, the base station may transmit multiple synchronization signal blocks (SSB) in a SSB burst, and the UE may report channel statistics of one or more beam pairs having the highest measured channel quality. To support dynamic beamforming and beam refinement, the base station may then generate a refined beam using a linear combination of static beams which the base station may determine based on one or more beams selected by the UE, and associated channel quality parameters for the selected beams.

In some examples, the UE may implement a number of techniques to report multiple preferred beams to the base station. In some examples, the base station may configure the UE to report multiple beams per channel state information-reference signal (CSI-RS) resource indicator (CRI) for dynamic beamforming, rather than reporting a single beam per CRI as in static beamforming. The UE 115-a may perform beam measurements for the multiple beams and may report various beamformed statistics associated with a respective CRI for each beam. In some other examples, the UE may select the top few clusters (e.g., two or more clusters) in the channel with the highest signal strength to report per CRI.

In some other examples, the base station may determine the N configured beams based on the CSI-RS measurements reported by the UE. In such examples, the base station may indicate a number of TCI states on which the configured beams are based, and the base station may use different beam weights with different combinations of the TCI states. Additionally or alternatively, the base station may apply a repetition to the CSI-RS resources, and the UE may determine a set of beam weights based on a combination of the received beam weights.

Aspects of the disclosure are initially described in the context of wireless communications systems. Aspects of the disclosure are further illustrated by and described with reference to apparatus diagrams, system diagrams, a process flow, and flowcharts that relate to methods for supporting multiple beams in CRI for generation of adaptive beam weights.

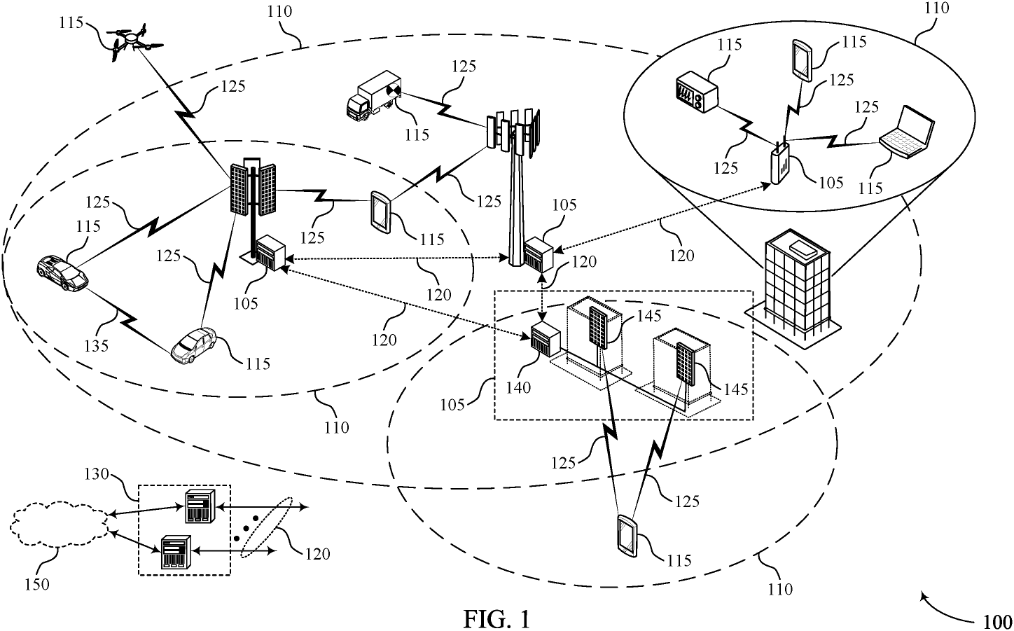

FIG. 1 illustrates an example of a wireless communications system 100 that supports methods for supporting multiple beams in CRI for generation of adaptive beam weights in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ = ⅟(Δfₘₐₓ ▪ N_{f} ) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beamforming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, devices such as UE 115 and base station 105 may support dynamic beamforming processes using dynamic beam weights to alter the magnitude and phase of a wave-front or signal, allowing the signaling energy to be split between multiple beams or combined into a single beam. During dynamic beamforming, a base station 105, a UE 115, or both, may dynamically adjust antenna phases or amplitudes to account for various channel conditions. For example, the base station 105, UE 115, or both, may assess channel statistics to determine beam weights to apply or may combine beam weights to dynamically change the direction of a transmitted beam.

During a beamforming procedure, a base station 105 may transmit a number of CSI-RSs in a SSB burst, and a UE 115 may report channel statistics of one or more beam pairs having the highest measured channel quality. To support dynamic beamforming and beam refinement, the base station may then generate a refined beam using a linear combination of static beams which are weighted appropriately by a respective set of weights. To inform the base station 105 of the selected beams or beam pairs, the UE 115 may include a CRI which indicates the selected beams. For example, the base station 105 may configure the UE 115 to report multiple beams per CRI (e.g., N beams per CRI). In some other examples, the UE 115 may select the top K clusters in the channel with the highest signal strength to report per CRI.

In some other examples, the base station 105 may determine the N configured beams based on the CSI-RS measurements reported by the UE 115. In such examples, the base station 105 may indicate a number of TCI states (e.g., N TCI states) on which the configured beams are based, and the base station may use different beam weights associated with the N TCI states.

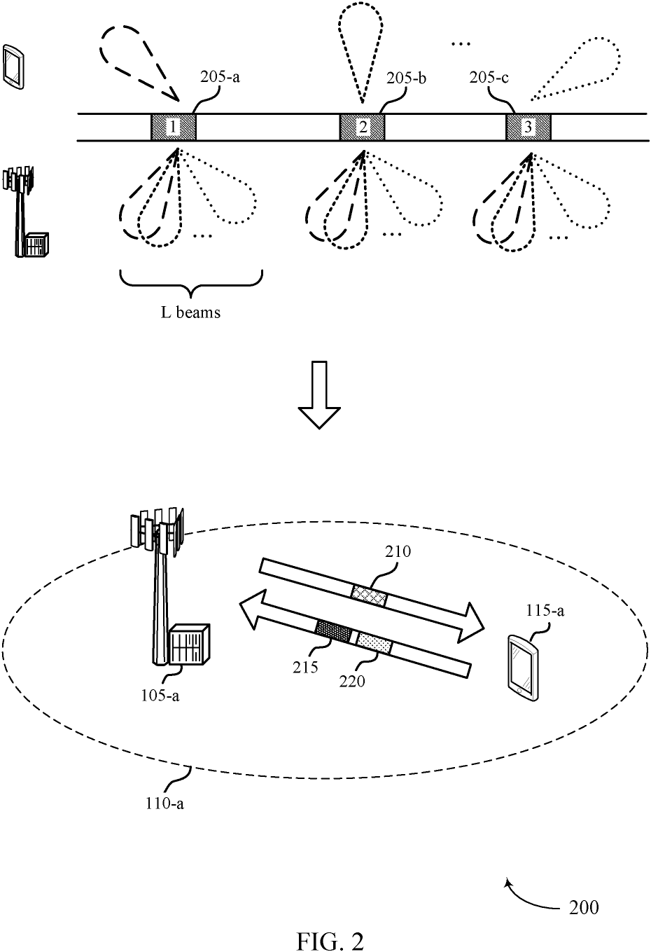

FIG. 2 illustrates an example of a wireless communications system 200 that supports methods for supporting multiple beams in CRI for generation of adaptive beam weights in accordance with aspects of the present disclosure. For example, wireless communications system may implement beamformed communications between a base station 105-a and a UE 115-a, which may be examples of base stations 105 and UE 115 described with reference to FIG. 1.

Some wireless communications systems such as wireless communications system 200 may use static beamforming processes to establish communication links between devices. For example, during a static beamforming procedure (e.g., in systems such as an NR or mmW system), base station 105-a or UE 115-a may use a number of different beamforming methods (e.g., codebook-based beamforming, directional analog or hybrid beamforming) to support devices with multiple-antenna capabilities and to bridge the link budget between the devices. In some such codebook-based beamforming methods, a device may use a fixed codebook with beam weights steering energy across pre-determined directions (e.g., stored in radio frequency integrated circuit (RFIC) memory) to perform beam training and to control a relative direction of a wave-front or signal by applying different weights to the magnitude and phase of individual antenna signals in an array of multiple antennas. For example, during an initial access procedure using a static codebook procedure, the base station 105-a may broadcast beams to cover the entire cell 110-a, and may implement hierarchical beam training (e.g., P1, P2, P3 procedures) to select a best beam to use as a static beam or beam pair for communication with the UE 115-a.

To increase the flexibility and robustness of static beamforming methods, in some implementations, the base station 105-a and the UE 115-a may support dynamic beamforming using dynamic beam weights, which allows for the signaling energy to be split across multiple directions to dynamically control the direction of the beamformed communications (e.g., rather than steering all of the energy in the single direction of a static beam). During dynamic beamforming, the base station 105-a or the UE 115-a may dynamically adjust antenna phase (e.g., phase shifts) or amplitude to account for various channel conditions. For example, the devices may assess channel statistics to determine beam weights to apply for beamforming.

By implementing dynamic beamforming approaches, the base station 105-a and the UE 115-a may more accurately account for polarization distortions or amplitude distortions that occur based on various device blockages, material properties of the UE 115-a (e.g., UE housing, cover, display units, sensors, camera impact), by combining and co-phasing energy across a wider angular spread of one or multiple antennas of the device.

During a beamforming procedure, the base station 105-a may transmit multiple synchronization signal blocks (SSB) in a SSB burst (e.g., SSBs 205-a, 205-b, and 205-c). For example, the base station 105-a may transmit a set of L beams (fi, ..., f_{L}), where L ≤ 64, and repeats these beams according to an SSB periodicity (e.g., 1.25, 5, 10 or 20 ms). The UE 115-a then searches through a different set of receive beams gi, ..., g_{K}, and reports channel statistics (e.g., reference signal received power (RSRP)) of one or more beam pairs having the highest measured RSRP. In some examples, the UE 115-a may report up to P beams (e.g., P ≤ 4), where P is configured as a size of a set of beams for beam refinement. The base station 105-a may transmit a set beams and the UE 115-a may indicate a set of fᵢ,1, ..., fᵢ,_{P} beam indices selected as having the highest RSRP by the UE 115-a. The base station 105-a may then use the fᵢ,1, ..., fᵢ,_{P} beam indices to generate P2 beam refinement over CSI-RS symbols.

To support dynamic beamforming and beam refinement, the base station 105-a may generate a refined beam using a linear combination of static beams f, which are weighted by respective set of weights α, which the base station 105-b may determine based on channel quality parameters (e.g., RSRP, SINR) reported from the UE 115-a. For example, the base station 105-b may generate beams of the form:

$${α}_{k} ⋅ {\text{f}}_{{i}_{k}} + {α}_{l} ⋅ {\text{f}}_{{i}_{l}} .$$

Different values for beam weights α may allow the base station 105-b to direct a first fraction of the signal energy in the direction of a first beam using a first weight and a second fraction of the signal energy in the direction of a second beam using a second weight. In some examples, the UE 115-a may report various beam measurements in a CSI report 215 which includes a CSI resource indicator (CRI) 220 indicating selected beams based on an indication 210 received from the base station configuring multiple beams per CRI. In some other examples, multiple CRIs may be associated with different channels and different beam measurements (e.g., CSI-RS) for different selected beams. The base station 105-a may receive CSI reporting including the indicated beams and may generate dynamic beams using a linear combination of the indicated beams and respective set of weights based on channel conditions. Additionally or alternatively, the UE 115-a may generate dynamic beams of the form:

$${α}_{k} ⋅ {g}_{{i}_{k}} + {α}_{l} ⋅ {\text{g}}_{{i}_{l}}$$

where g are static UE beams, and α are beam weights determined based on channel conditions.

The UE 115-a may implement a number of techniques to report multiple beams configured per CRI and to notify the base station 105-a of the selected beams. In some examples, the base station 105-a may configure the UE 115-a to report multiple beams per CRI (e.g., N beams per CRI). The UE 115-a may perform beam measurements for the multiple beams and may report RSRP (among other beam measurements) associated with a respective CRI for each beam. In some implementations, the base station 105-a may configure a different number of beams for each different CRI such that the UE 115-a may select a different number of beams to report per CRI.

In some other examples, the number of beams configured may be based on SSB measurements made by the UE 115-a. For example, the UE 115-a may select the top K clusters in the channel with the highest signal strength to report per CRI. In such examples, the UE 115-a may determine that a number of beams N in the channel have the highest measured RSRP, such that N = K, and the UE 115-a may report N beams per CRI to the base station 105-a. In some cases, the UE 115-a may determine to report two beams per CRI (e.g., N = 2) to capture the strongest beams in the channel, although other values of N are possible.

In some other examples, the base station 105-a may determine the N configured beams based on the SSB measurements reported by the UE 115-a. In such examples, the base station 105-a may indicate a number of TCI states (e.g., N TCI states) on which the configured beams are based. The base station may use different beam weights with different combinations of the N TCI states, and may indicate the corresponding set of N weights, or a weight set index, in addition to or instead of the N indicated TCI states. In some cases, the base station 105-a may configure the beam weights based additional beam reports (e.g., CSI reports) received from different UEs in the wireless communications system 200, and in some such cases, the base station 105-a may configure a set of beams to the UE 115-a which are different from the set of beams reported by the UE 115-a.

In some other examples, the base station 105-a may implement bi-directional or adaptive beam weight learning techniques to establish and maintain the dynamic beams. For example, the base station 105-a may indicate N TCI states with a same set of CSI-RS resources with repetition ON (e.g., the base station may implement repetition to repeat beam training process across beams transmitted to the UE 115-a). The UE 115-a may measure each CSI-RS resource with a weighted combination of the N corresponding receive beam weight vectors, and may determine a beam weight vector to use via the weight sweep. In such cases, the UE 115-a may determine a “best” set of beam weights (e.g., relative to other receive beams) by determining beams with the highest signal strength over each repetition. In some cases, the base station 105-a may transmit an indication to the UE 115-a which indicates whether the UE 115-a is to perform a full receive beam sweep (e.g., a P3 procedure) or a beam weight sweep across the N receive beams for the N indicated TCI states.

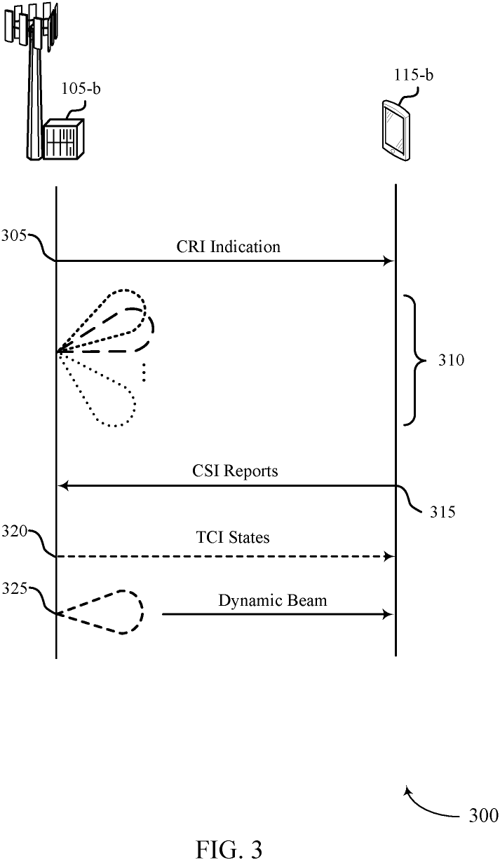

FIG. 3 illustrates an example of a process flow 300 that supports methods for supporting multiple beams in CRI for generation of adaptive beam weights in accordance with aspects of the present disclosure. The process flow 300 may implement aspects of wireless communications systems 100 or 200, or may be implemented by aspects of the wireless communications system 100 and 200. For example, the process flow 300 may illustrate operations between a UE 115-b and a base station 105-b, which may be examples of corresponding devices described with reference to FIGS. 1 and 2. In the following description of the process flow 300, the operations between the devices may be transmitted in a different order than the example order shown, or the operations may be performed in different orders or at different times or by different devices. Additionally or alternatively, some operations may also be omitted from the process flow 300, and other operations may be added to the process flow 300.

At 305, the base station 105-b may transmit, and the UE 115-b may receive, an indication that a CRI is associated with two or more beams. In some cases, different CRIs may be associated with the same number or different numbers of beams.

At 310, the base station 105-b may transmit a downlink burst including one or more CSI-RSs for measurement by the UE 115-b. The UE 115-b may monitor the downlink burst for the one or more CSI-RSs in accordance with the CRI.

At 315, the UE 115-b may transmit, and the base station 105-b may receive, one or more CSI-reports for the two or more beams. In some examples, the UE 115-b may measure an RSRP value for each of the two or more beams indicated by the CRI, and may transmit the one or more CSI reports including the RSRP measurements for the two or more beams.

In some examples, the UE 115-b may select the two or more beams by comparing RSRP values of the two or more beams to a threshold RSRP value. The UE 115-b may select the two or more beams based on the beams exceeding the threshold RSRP, and may transmit an indication of the selected beams to the base station 105-b. In some examples, the two or more beams may be the total number of beams in the channel which have measured RSRP exceeding the threshold RSRP.

At 320, the base station 105-b may optionally transmit, and the UE 115-b may optionally receive, a set of TCI states associated with the two or more beams, and the UE 115-b may select the two or more beams based on the set of TCI states. In some examples, each TCI state of the set of TCI states may be associated with a respective beam weight, a set of beam weights, a beam weight set index, or any combination thereof.

Additionally or alternatively, the base station 105-b may transmit, and the UE 115-b may receive the set of TCI states including a repetition factor associated with the one or more CSI-RSs. The base station 105-b may transmit, and the UE 115-b may receive, one or more repetitions of the one or more CSI-RSs in accordance with the repetition factor, and the UE may determine a beam weight factor that the base station 105-b may use in subsequent beamforming. In some other examples, the UE 115-b may determine the beam weight factor based on a weighted combination of a set of beam weight vectors associated with the repeated CSI-RSs.

In some other examples, the UE 115-b may receive an indication that the UE 115-b is to perform a full beam sweep or a partial beam sweep across beams of the indicated set of TCI states. The UE 115-b may determine the beam weight factor based on a weighted combination of beam weights of the full beam sweep or the partial beam sweep.

At 325, the base station 105-b may transmit, and the UE 115-b may receive, a downlink transmission over a weighted combination of the two or more beams, where the weighted combination is based on the received CSI-RSs.

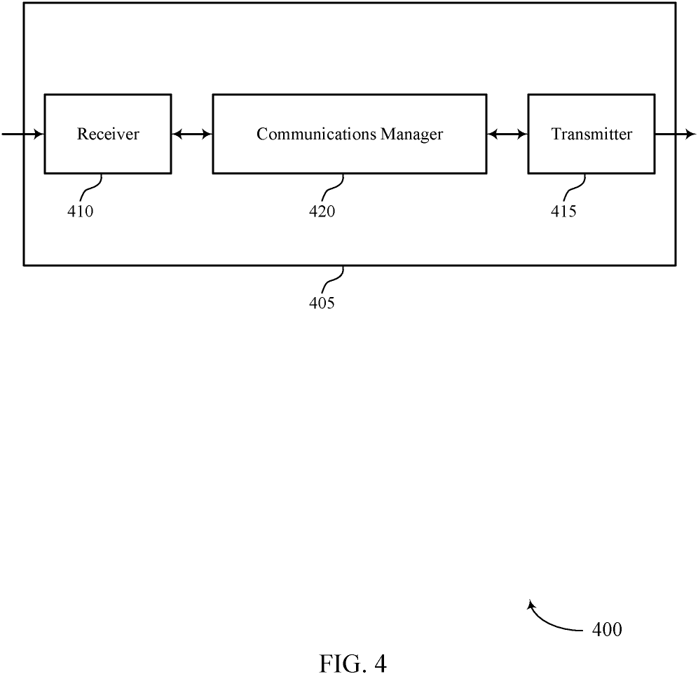

FIG. 4 shows a block diagram 400 of a device 405 that supports methods for supporting multiple beams in CRI for generation of adaptive beam weights in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to methods for supporting multiple beams in CRI for generation of adaptive beam weights). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to methods for supporting multiple beams in CRI for generation of adaptive beam weights). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of methods for supporting multiple beams in CRI for generation of adaptive beam weights as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving, from a base station, an indication that a CRI is associated with two or more beams. The communications manager 420 may be configured as or otherwise support a means for monitoring, from the base station, a downlink burst including one or more CSI-RSs for measurement by the UE in accordance with the CSI-RS resource indicator. The communications manager 420 may be configured as or otherwise support a means for transmitting, to the base station, one or more CSI reports for the two or more beams based on the measurement.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, more efficient utilization of communication resources by configuring multiple beams per CRI.

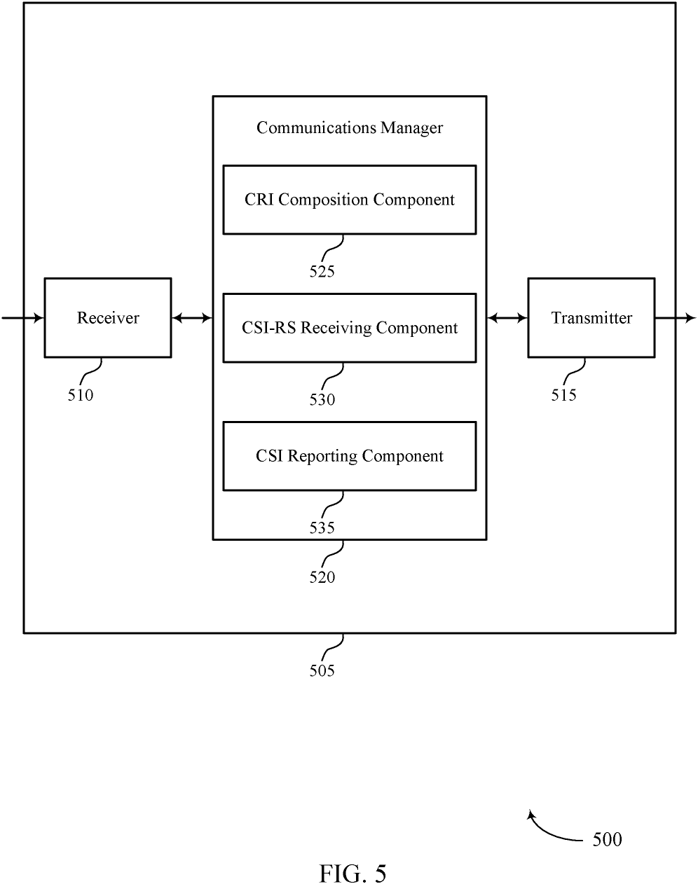

FIG. 5 shows a block diagram 500 of a device 505 that supports methods for supporting multiple beams in CRI for generation of adaptive beam weights in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to methods for supporting multiple beams in CRI for generation of adaptive beam weights). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to methods for supporting multiple beams in CRI for generation of adaptive beam weights). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of methods for supporting multiple beams in CRI for generation of adaptive beam weights as described herein. For example, the communications manager 520 may include a CRI composition component 525, a CSI-RS receiving component 530, a CSI reporting component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The CRI composition component 525 may be configured as or otherwise support a means for receiving, from a base station, an indication that a CRI is associated with two or more beams. The CSI-RS receiving component 530 may be configured as or otherwise support a means for monitoring, from the base station, a downlink burst including one or more CSI-RSs for measurement by the UE in accordance with the CSI-RS resource indicator. The CSI reporting component 535 may be configured as or otherwise support a means for transmitting, to the base station, one or more CSI reports for the two or more beams based on the measurement.

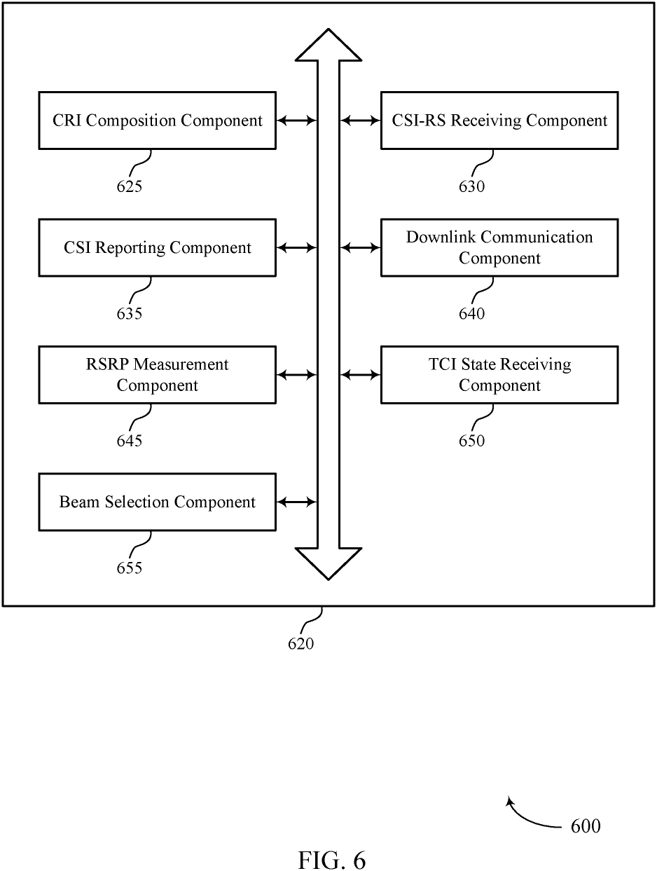

FIG. 6 shows a block diagram 600 of a communications manager 620 that supports methods for supporting multiple beams in CRI for generation of adaptive beam weights in accordance with aspects of the present disclosure. The communications manager 620 may be an example of aspects of a communications manager 420, a communications manager 520, or both, as described herein. The communications manager 620, or various components thereof, may be an example of means for performing various aspects of methods for supporting multiple beams in CRI for generation of adaptive beam weights as described herein. For example, the communications manager 620 may include a CRI composition component 625, a CSI-RS receiving component 630, a CSI reporting component 635, a downlink communication component 640, an RSRP measurement component 645, a TCI state receiving component 650, a beam selection component 655, or any combination thereof. Each of these components may communicate, directly or indirectly, with one another (e.g., via one or more buses).

The communications manager 620 may support wireless communication at a UE in accordance with examples as disclosed herein. The CRI composition component 625 may be configured as or otherwise support a means for receiving, from a base station, an indication that a CRI is associated with two or more beams. The CSI-RS receiving component 630 may be configured as or otherwise support a means for monitoring, from the base station, a downlink burst including one or more CSI-RSs for measurement by the UE in accordance with the CSI-RS resource indicator. The CSI reporting component 635 may be configured as or otherwise support a means for transmitting, to the base station, one or more CSI reports for the two or more beams based on the measurement.

In some examples, the downlink communication component 640 may be configured as or otherwise support a means for receiving, from the base station, a downlink transmission over a weighted combination of the two or more beams in accordance with the one or more CSI reports.

In some examples, to support monitoring, the RSRP measurement component 645 may be configured as or otherwise support a means for measuring a RSRP for each of the two or more beams indicated by the CSI-RS resource indicator. In some examples, to support monitoring, the CSI reporting component 635 may be configured as or otherwise support a means for transmitting, to the base station, the one or more CSI reports including the measured RSRP for the two or more beams.

In some examples, the beam selection component 655 may be configured as or otherwise support a means for selecting the two or more beams based on a threshold RSRP for measurements of the one or more CSI-RSs. In some examples, the beam selection component 655 may be configured as or otherwise support a means for transmitting, to the base station, an indication of the two or more beams associated with the CSI-RS resource indicator, the two or more beams having a RSRP that exceeds the threshold.

In some examples, the two or more beams include a total number of beams in a channel having a RSRP that exceeds the threshold.

In some examples, the transmission configuration indicator (TCI) state receiving component 650 may be configured as or otherwise support a means for receiving, from the base station, a set of TCI states associated with the two or more beams. In some examples, the beam selection component 655 may be configured as or otherwise support a means for selecting the two or more beams based on the set of TCI states.

In some examples, each TCI state of the set of TCI states is associated with a beam weight, a set of beam weights, a beam weight set index, or any combination thereof.

In some examples, the TCI state receiving component 650 may be configured as or otherwise support a means for receiving, from the base station, an indication of a set of TCI states and a repetition factor associated with the one or more CSI-RSs. In some examples, the CSI-RS receiving component 630 may be configured as or otherwise support a means for receiving, from the base station, one or more repetitions of the one or more CSI-RSs in accordance with the repetition factor. In some examples, the beam selection component 655 may be configured as or otherwise support a means for determining a beam weight factor to be used in analog beamforming, hybrid beamforming, or both, based on the one or more repetitions of the one or more CSI-RSs.

In some examples, the beam selection component 655 may be configured as or otherwise support a means for determining the beam weight factor based on a weighted combination of a set of beam weight vectors associated with the one or more repetitions of the one or more CSI-RSs.

In some examples, the beam selection component 655 may be configured as or otherwise support a means for receiving, from the base station, an indication that the UE is to perform a full beam sweep or a partial beam sweep across beams of the indicated set of TCI states. In some examples, the beam selection component 655 may be configured as or otherwise support a means for determining the beam weight factor based on a weighted combination of beam weights of the full beam sweep or the partial beam sweep.

In some examples, the two or more beams include a different number of beams for different CSI-RS resource indicators.

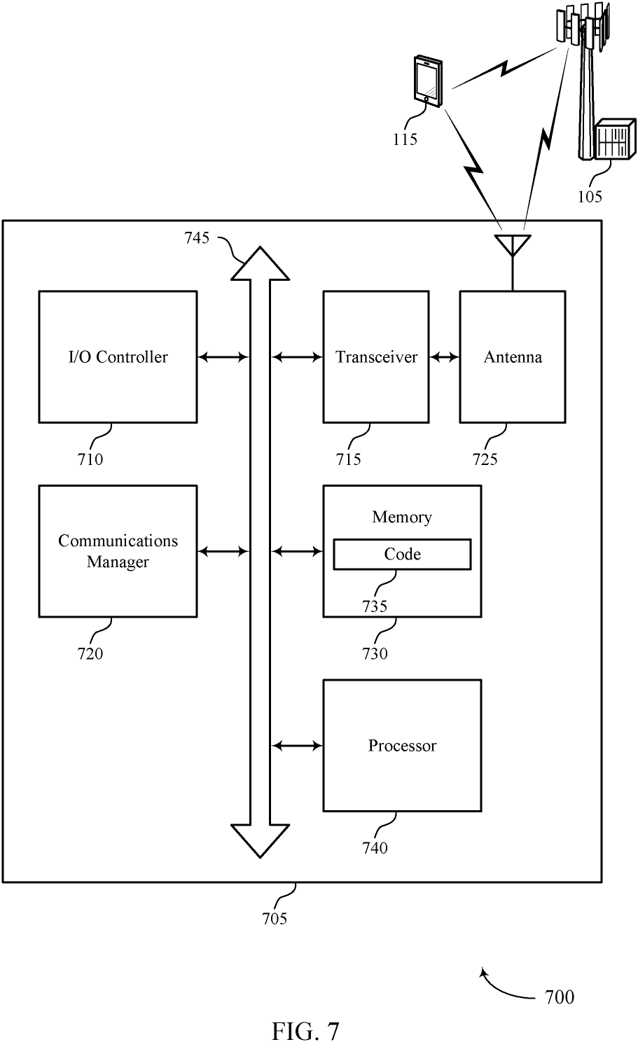

FIG. 7 shows a diagram of a system 700 including a device 705 that supports methods for supporting multiple beams in CRI for generation of adaptive beam weights in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting methods for supporting multiple beams in CRI for generation of adaptive beam weights). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, from a base station, an indication that a CRI is associated with two or more beams. The communications manager 720 may be configured as or otherwise support a means for monitoring, from the base station, a downlink burst including one or more CSI-RSs for measurement by the UE in accordance with the CSI-RS resource indicator. The communications manager 720 may be configured as or otherwise support a means for transmitting, to the base station, one or more CSI reports for the two or more beams based on the measurement.

By including or configuring the communications manager 720 in accordance with examples as described herein, the device 705 may support techniques for improved communication reliability, reduced latency, improved user experience related to reduced processing and more accurate beamforming, reduced power consumption, more efficient utilization of communication resources, improved adaptation to changing channel conditions, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of methods for supporting multiple beams in CRI for generation of adaptive beam weights as described herein, or the processor 740 and the memory 730 may be otherwise configured to perform or support such operations.

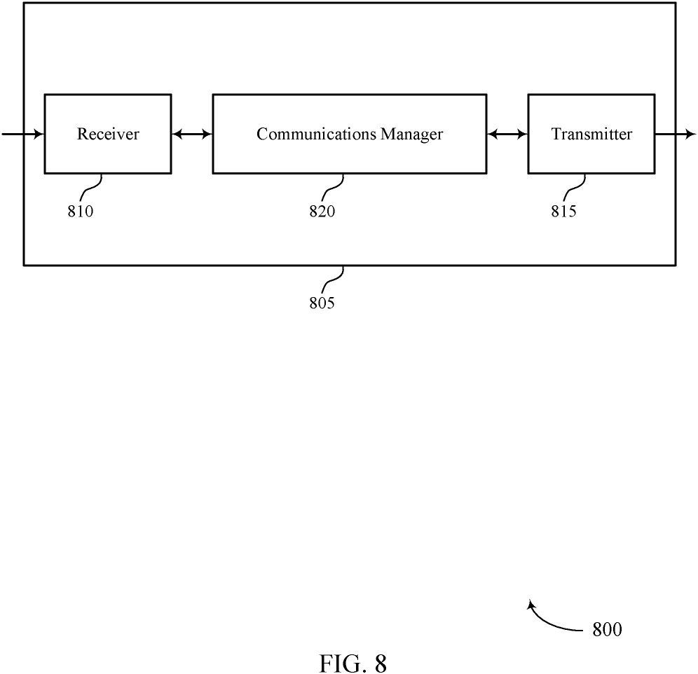

FIG. 8 shows a block diagram 800 of a device 805 that supports methods for supporting multiple beams in CRI for generation of adaptive beam weights in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to methods for supporting multiple beams in CRI for generation of adaptive beam weights). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to methods for supporting multiple beams in CRI for generation of adaptive beam weights). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of methods for supporting multiple beams in CRI for generation of adaptive beam weights as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station in accordance with examples as disclosed herein. For example, the communications manager 820 may be configured as or otherwise support a means for transmitting, to a UE, an indication that a CRI is associated with two or more beams. The communications manager 820 may be configured as or otherwise support a means for transmitting, to the UE, a downlink burst including one or more CSI-RSs for measurement by the UE in accordance with the CSI-RS resource indicator. The communications manager 820 may be configured as or otherwise support a means for receiving, from the UE, one or more CSI reports for the two or more beams based on the measurement.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources based on indicating multiple beams per CRI.

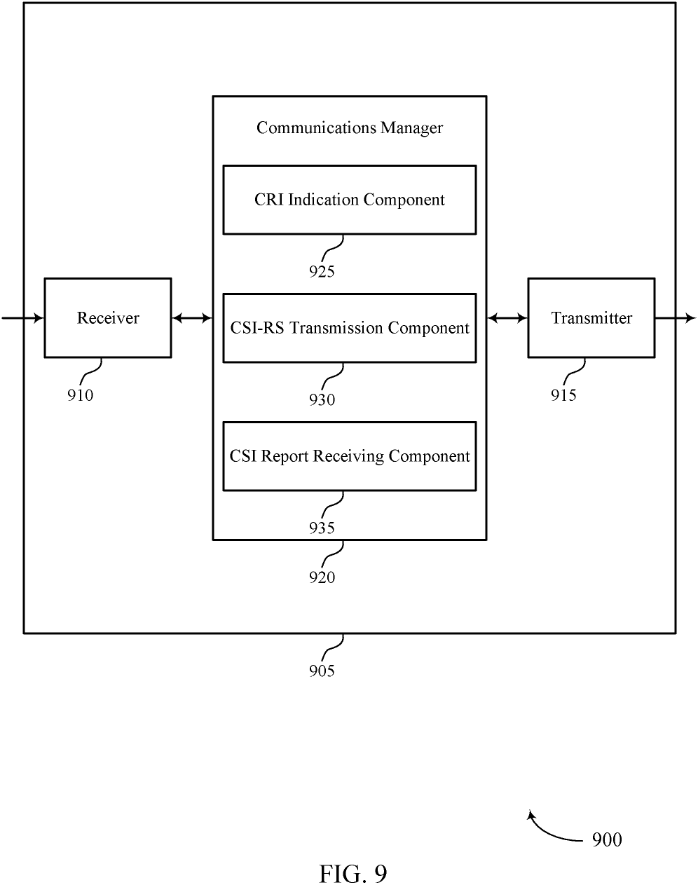

FIG. 9 shows a block diagram 900 of a device 905 that supports methods for supporting multiple beams in CRI for generation of adaptive beam weights in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to methods for supporting multiple beams in CRI for generation of adaptive beam weights). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to methods for supporting multiple beams in CRI for generation of adaptive beam weights). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of methods for supporting multiple beams in CRI for generation of adaptive beam weights as described herein. For example, the communications manager 920 may include a CRI indication component 925, a CSI-RS transmission component 930, a CSI report receiving component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. The CRI indication component 925 may be configured as or otherwise support a means for transmitting, to a UE, an indication that a CRI is associated with two or more beams. The CSI-RS transmission component 930 may be configured as or otherwise support a means for transmitting, to the UE, a downlink burst including one or more CSI-RSs for measurement by the UE in accordance with the CSI-RS resource indicator. The CSI report receiving component 935 may be configured as or otherwise support a means for receiving, from the UE, one or more CSI reports for the two or more beams based on the measurement.

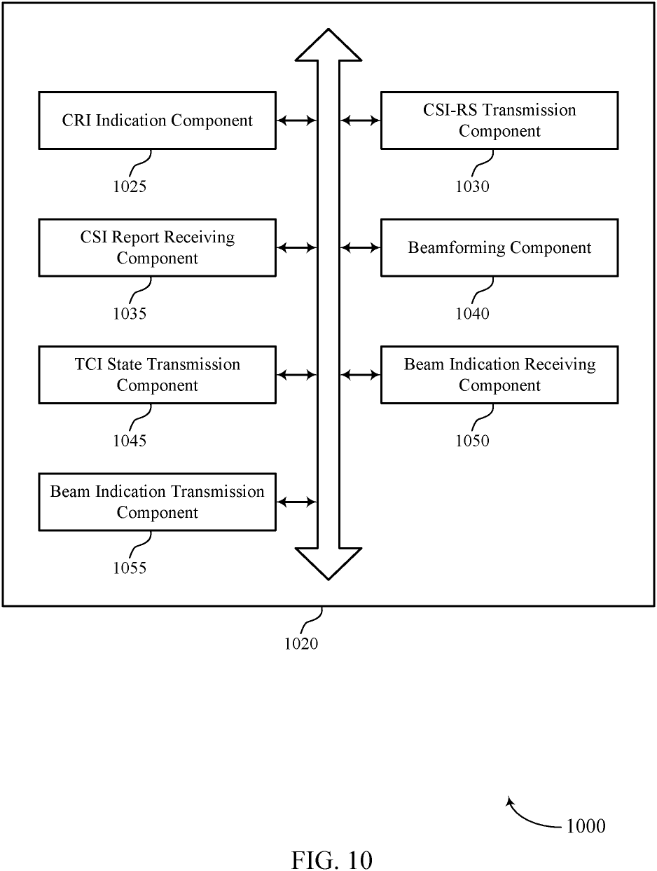

FIG. 10 shows a block diagram 1000 of a communications manager 1020 that supports methods for supporting multiple beams in CRI for generation of adaptive beam weights in accordance with aspects of the present disclosure. The communications manager 1020 may be an example of aspects of a communications manager 820, a communications manager 920, or both, as described herein. The communications manager 1020, or various components thereof, may be an example of means for performing various aspects of methods for supporting multiple beams in CRI for generation of adaptive beam weights as described herein. For example, the communications manager 1020 may include a CRI indication component 1025, a CSI-RS transmission component 1030, a CSI report receiving component 1035, a beamforming component 1040, a TCI state transmission component 1045, a beam indication receiving component 1050, a beam indication transmission component 1055, or any combination thereof. Each of these components may communicate, directly or indirectly, with one another (e.g., via one or more buses).

The communications manager 1020 may support wireless communication at a base station in accordance with examples as disclosed herein. The CRI indication component 1025 may be configured as or otherwise support a means for transmitting, to a UE, an indication that a CRI is associated with two or more beams. The CSI-RS transmission component 1030 may be configured as or otherwise support a means for transmitting, to the UE, a downlink burst including one or more CSI-RSs for measurement by the UE in accordance with the CSI-RS resource indicator. The CSI report receiving component 1035 may be configured as or otherwise support a means for receiving, from the UE, one or more CSI reports for the two or more beams based on the measurement.

In some examples, the beamforming component 1040 may be configured as or otherwise support a means for transmitting, to the UE, a downlink transmission over a weighted combination of the two or more beams in accordance with the one or more CSI reports.

In some examples, to support monitoring, the CSI report receiving component 1035 may be configured as or otherwise support a means for receiving, from the UE, the one or more CSI reports including a measured RSRP for each of the two or more beams indicated by the CSI-RS resource indicator.

In some examples, the beam indication receiving component 1050 may be configured as or otherwise support a means for receiving, from the UE, an indication of the two or more beams associated with the CSI-RS resource indicator, the two or more beams having a RSRP that exceeds a threshold RSRP for measurements of the one or more CSI-RSs.

In some examples, the two or more beams include a total number of beams in a channel having a RSRP that exceeds the threshold.

In some examples, the TCI state transmission component 1045 may be configured as or otherwise support a means for transmitting, to the UE, a set of TCI states associated with the two or more beams.

In some examples, each TCI state of the set of TCI states is associated with a beam weight, a set of beam weights, a beam weight set index, or any combination thereof.

In some examples, the beam indication transmission component 1055 may be configured as or otherwise support a means for transmitting, to the UE, a selection of the two or more beams based on one or more different CSI reports received from at least one other UE.

In some examples, the TCI state transmission component 1045 may be configured as or otherwise support a means for transmitting, to the UE, an indication of a set of TCI states and a repetition factor associated with the one or more CSI-RSs. In some examples, the CSI-RS transmission component 1030 may be configured as or otherwise support a means for transmitting, to the UE, one or more repetitions of the one or more CSI-RSs in accordance with the repetition factor. In some examples, the beam indication receiving component 1050 may be configured as or otherwise support a means for receiving, from the UE, a beam having a beam weight factor based on the one or more repetitions of the one or more CSI-RSs.

In some examples, the beam weight factor is based on a weighted combination of a set of beam weight vectors associated with the one or more repetitions of the one or more CSI-RSs.

In some examples, the beam indication transmission component 1055 may be configured as or otherwise support a means for transmitting, to the UE, an indication that the UE is to perform a full beam sweep or a partial beam sweep across beams of the indicated set of TCI states.

In some examples, the two or more beams include a different number of beams for different CSI-RS resource indicators.

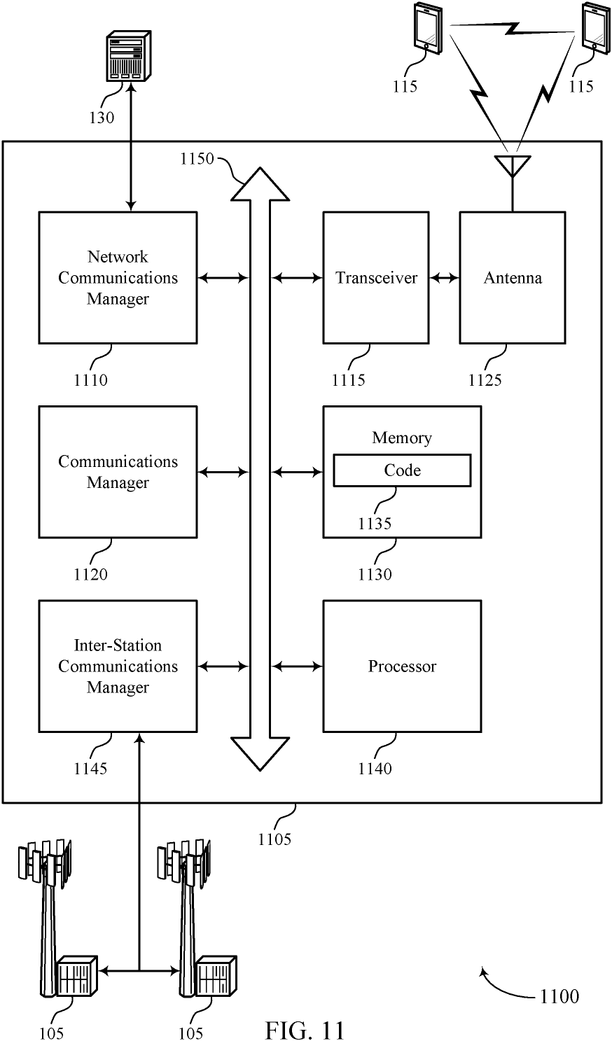

FIG. 11 shows a diagram of a system 1100 including a device 1105 that supports methods for supporting multiple beams in CRI for generation of adaptive beam weights in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting methods for supporting multiple beams in CRI for generation of adaptive beam weights). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for transmitting, to a UE, an indication that a CRI is associated with two or more beams. The communications manager 1120 may be configured as or otherwise support a means for transmitting, to the UE, a downlink burst including one or more CSI-RSs for measurement by the UE in accordance with the CSI-RS resource indicator. The communications manager 1120 may be configured as or otherwise support a means for receiving, from the UE, one or more CSI reports for the two or more beams based on the measurement.

By including or configuring the communications manager 1120 in accordance with examples as described herein, the device 1105 may support techniques for improved communication reliability, reduced latency, improved user experience related to reduced processing and more accurate beamforming, reduced power consumption, more efficient utilization of communication resources, improved adaptation to changing channel conditions, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of methods for supporting multiple beams in CRI for generation of adaptive beam weights as described herein, or the processor 1140 and the memory 1130 may be otherwise configured to perform or support such operations.

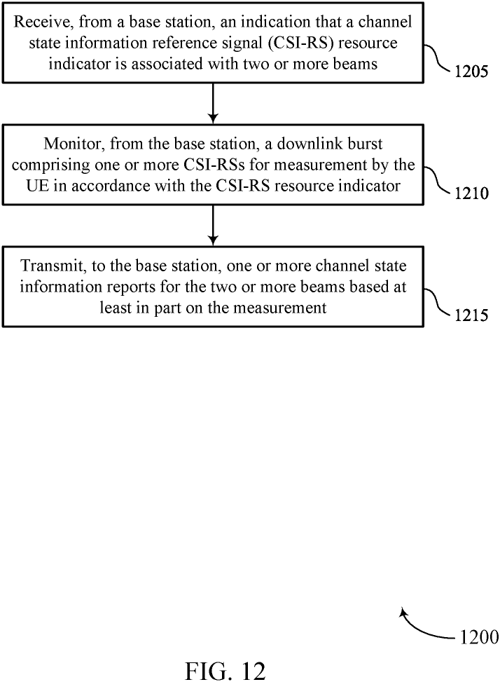

FIG. 12 shows a flowchart illustrating a method 1200 that supports methods for supporting multiple beams in CRI for generation of adaptive beam weights in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, an indication that a CRI is associated with two or more beams. The operations of 1205 may be performed in accordance with examples as disclosed herein. In some examples, aspects of the operations of 1205 may be performed by a CRI composition component 625 as described with reference to FIG. 6.

At 1210, the method may include monitoring, from the base station, a downlink burst including one or more CSI-RSs for measurement by the UE in accordance with the CSI-RS resource indicator. The operations of 1210 may be performed in accordance with examples as disclosed herein. In some examples, aspects of the operations of 1210 may be performed by a CSI-RS receiving component 630 as described with reference to FIG. 6.

At 1215, the method may include transmitting, to the base station, one or more CSI reports for the two or more beams based on the measurement. The operations of 1215 may be performed in accordance with examples as disclosed herein. In some examples, aspects of the operations of 1215 may be performed by a CSI reporting component 635 as described with reference to FIG. 6.

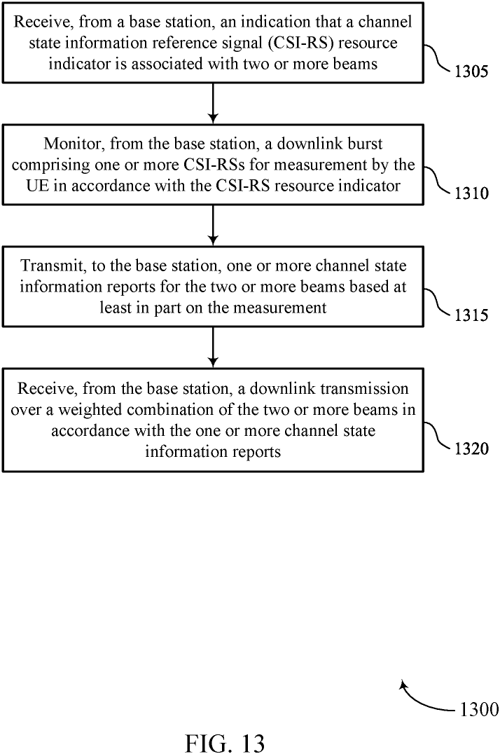

FIG. 13 shows a flowchart illustrating a method 1300 that supports methods for supporting multiple beams in CRI for generation of adaptive beam weights in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, an indication that a CRI is associated with two or more beams. The operations of 1305 may be performed in accordance with examples as disclosed herein. In some examples, aspects of the operations of 1305 may be performed by a CRI composition component 625 as described with reference to FIG. 6.

At 1310, the method may include monitoring, from the base station, a downlink burst including one or more CSI-RSs for measurement by the UE in accordance with the CSI-RS resource indicator. The operations of 1310 may be performed in accordance with examples as disclosed herein. In some examples, aspects of the operations of 1310 may be performed by a CSI-RS receiving component 630 as described with reference to FIG. 6.

At 1315, the method may include transmitting, to the base station, one or more CSI reports for the two or more beams based on the measurement. The operations of 1315 may be performed in accordance with examples as disclosed herein. In some examples, aspects of the operations of 1315 may be performed by a CSI reporting component 635 as described with reference to FIG. 6.

At 1320, the method may include receiving, from the base station, a downlink transmission over a weighted combination of the two or more beams in accordance with the one or more CSI reports. The operations of 1320 may be performed in accordance with examples as disclosed herein. In some examples, aspects of the operations of 1320 may be performed by a downlink communication component 640 as described with reference to FIG. 6.

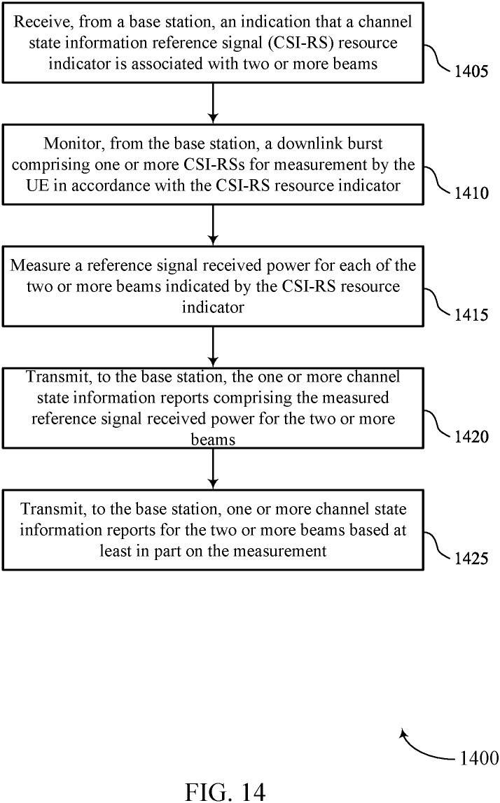

FIG. 14 shows a flowchart illustrating a method 1400 that supports methods for supporting multiple beams in CRI for generation of adaptive beam weights in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, an indication that a CRI is associated with two or more beams. The operations of 1405 may be performed in accordance with examples as disclosed herein. In some examples, aspects of the operations of 1405 may be performed by a CRI composition component 625 as described with reference to FIG. 6.

At 1410, the method may include monitoring, from the base station, a downlink burst including one or more CSI-RSs for measurement by the UE in accordance with the CSI-RS resource indicator. The operations of 1410 may be performed in accordance with examples as disclosed herein. In some examples, aspects of the operations of 1410 may be performed by a CSI-RS receiving component 630 as described with reference to FIG. 6.

At 1415, the method may include measuring a RSRP for each of the two or more beams indicated by the CSI-RS resource indicator. The operations of 1415 may be performed in accordance with examples as disclosed herein. In some examples, aspects of the operations of 1415 may be performed by an RSRP measurement component 645 as described with reference to FIG. 6.

At 1420, the method may include transmitting, to the base station, the one or more CSI reports including the measured RSRP for the two or more beams. The operations of 1420 may be performed in accordance with examples as disclosed herein. In some examples, aspects of the operations of 1420 may be performed by a CSI reporting component 635 as described with reference to FIG. 6.

At 1425, the method may include transmitting, to the base station, one or more CSI reports for the two or more beams based on the measurement. The operations of 1425 may be performed in accordance with examples as disclosed herein. In some examples, aspects of the operations of 1425 may be performed by a CSI reporting component 635 as described with reference to FIG. 6.

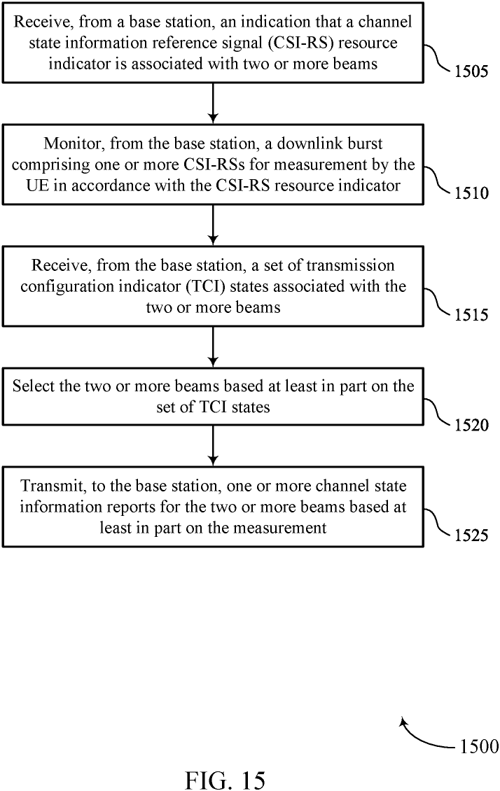

FIG. 15 shows a flowchart illustrating a method 1500 that supports methods for supporting multiple beams in CRI for generation of adaptive beam weights in accordance with aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, an indication that a CRI is associated with two or more beams. The operations of 1505 may be performed in accordance with examples as disclosed herein. In some examples, aspects of the operations of 1505 may be performed by a CRI composition component 625 as described with reference to FIG. 6.

At 1510, the method may include monitoring, from the base station, a downlink burst including one or more CSI-RSs for measurement by the UE in accordance with the CSI-RS resource indicator. The operations of 1510 may be performed in accordance with examples as disclosed herein. In some examples, aspects of the operations of 1510 may be performed by a CSI-RS receiving component 630 as described with reference to FIG. 6.

At 1515, the method may include receiving, from the base station, a set of TCI states associated with the two or more beams. The operations of 1515 may be performed in accordance with examples as disclosed herein. In some examples, aspects of the operations of 1515 may be performed by a TCI state receiving component 650 as described with reference to FIG. 6.

At 1520, the method may include selecting the two or more beams based on the set of TCI states. The operations of 1520 may be performed in accordance with examples as disclosed herein. In some examples, aspects of the operations of 1520 may be performed by a beam selection component 655 as described with reference to FIG. 6.

At 1525, the method may include transmitting, to the base station, one or more CSI reports for the two or more beams based on the measurement. The operations of 1525 may be performed in accordance with examples as disclosed herein. In some examples, aspects of the operations of 1525 may be performed by a CSI reporting component 635 as described with reference to FIG. 6.

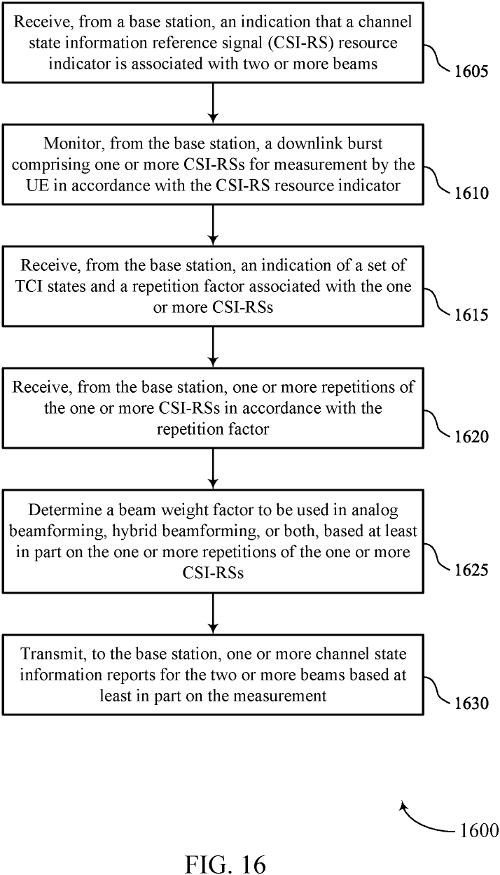

FIG. 16 shows a flowchart illustrating a method 1600 that supports methods for supporting multiple beams in CRI for generation of adaptive beam weights in accordance with aspects of the present disclosure. The operations of the method 1600 may be implemented by a UE or its components as described herein. For example, the operations of the method 1600 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, an indication that a CRI is associated with two or more beams. The operations of 1605 may be performed in accordance with examples as disclosed herein. In some examples, aspects of the operations of 1605 may be performed by a CRI composition component 625 as described with reference to FIG. 6.

At 1610, the method may include monitoring, from the base station, a downlink burst including one or more CSI-RSs for measurement by the UE in accordance with the CSI-RS resource indicator. The operations of 1610 may be performed in accordance with examples as disclosed herein. In some examples, aspects of the operations of 1610 may be performed by a CSI-RS receiving component 630 as described with reference to FIG. 6.

At 1615, the method may include receiving, from the base station, an indication of a set of TCI states and a repetition factor associated with the one or more CSI-RSs. The operations of 1615 may be performed in accordance with examples as disclosed herein. In some examples, aspects of the operations of 1615 may be performed by a TCI state receiving component 650 as described with reference to FIG. 6.

At 1620, the method may include receiving, from the base station, one or more repetitions of the one or more CSI-RSs in accordance with the repetition factor. The operations of 1620 may be performed in accordance with examples as disclosed herein. In some examples, aspects of the operations of 1620 may be performed by a CSI-RS receiving component 630 as described with reference to FIG. 6.

At 1625, the method may include determining a beam weight factor to be used in analog beamforming, hybrid beamforming, or both, based on the one or more repetitions of the one or more CSI-RSs. The operations of 1625 may be performed in accordance with examples as disclosed herein. In some examples, aspects of the operations of 1625 may be performed by a beam selection component 655 as described with reference to FIG. 6.

At 1630, the method may include transmitting, to the base station, one or more CSI reports for the two or more beams based on the measurement. The operations of 1630 may be performed in accordance with examples as disclosed herein. In some examples, aspects of the operations of 1630 may be performed by a CSI reporting component 635 as described with reference to FIG. 6.

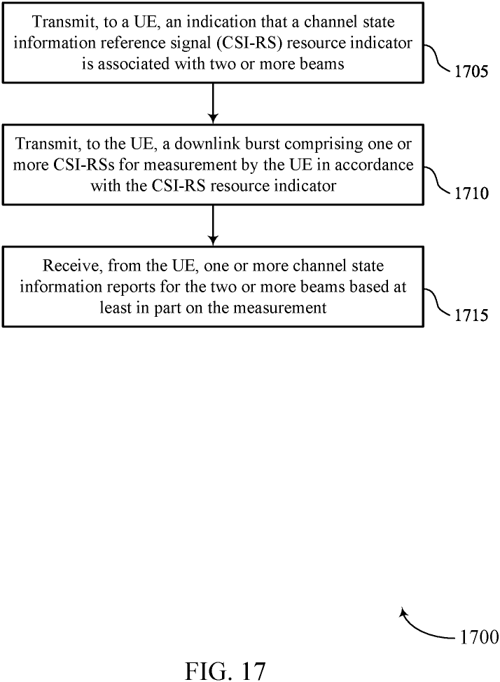

FIG. 17 shows a flowchart illustrating a method 1700 that supports methods for supporting multiple beams in CRI for generation of adaptive beam weights in accordance with aspects of the present disclosure. The operations of the method 1700 may be implemented by a base station or its components as described herein. For example, the operations of the method 1700 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, an indication that a CRI is associated with two or more beams. The operations of 1705 may be performed in accordance with examples as disclosed herein. In some examples, aspects of the operations of 1705 may be performed by a CRI indication component 1025 as described with reference to FIG. 10.

At 1710, the method may include transmitting, to the UE, a downlink burst including one or more CSI-RSs for measurement by the UE in accordance with the CSI-RS resource indicator. The operations of 1710 may be performed in accordance with examples as disclosed herein. In some examples, aspects of the operations of 1710 may be performed by a CSI-RS transmission component 1030 as described with reference to FIG. 10.

At 1715, the method may include receiving, from the UE, one or more CSI reports for the two or more beams based on the measurement. The operations of 1715 may be performed in accordance with examples as disclosed herein. In some examples, aspects of the operations of 1715 may be performed by a CSI report receiving component 1035 as described with reference to FIG. 10.

The following provides an overview of aspects of the present disclosure:

Aspect 1: A method for wireless communication at a UE, comprising: receiving, from a base station, an indication that a CRI is associated with two or more beams; monitoring, from the base station, a downlink burst comprising one or more CSI-RSs for measurement by the UE in accordance with the CRI; and transmitting, to the base station, one or more CSI reports for the two or more beams based at least in part on the measurement.

Aspect 2: The method of aspect 1, further comprising: receiving, from the base station, a downlink transmission over a weighted combination of the two or more beams in accordance with the one or more CSI reports.

Aspect 3: The method of any of aspects 1 through 2, wherein the monitoring further comprises: measuring a RSRP for each of the two or more beams indicated by the CRI; and transmitting, to the base station, the one or more CSI reports comprising the measured RSRP for the two or more beams.

Aspect 4: The method of aspect 3, further comprising: selecting the two or more beams based at least in part on a threshold RSRP for measurements of the one or more CSI-RSs; transmitting, to the base station, an indication of the two or more beams associated with the CRI, the two or more beams having a RSRP that exceeds the threshold.

Aspect 5: The method of any of aspects 3 through 4, wherein the two or more beams comprise a total number of beams in a channel having a RSRP that exceeds the threshold.

Aspect 6: The method of any of aspects 1 through 5, further comprising: receiving, from the base station, a set of TCI states associated with the two or more beams; and selecting the two or more beams based at least in part on the set of TCI states.

Aspect 7: The method of aspect 6, wherein each TCI state of the set of TCI states is associated with a beam weight, a set of beam weights, a beam weight set index, or any combination thereof.

Aspect 8: The method of any of aspects 1 through 7, further comprising: receiving, from the base station, an indication of a set of TCI states and a repetition factor associated with the one or more CSI-RSs; receiving, from the base station, one or more repetitions of the one or more CSI-RSs in accordance with the repetition factor; and determining a beam weight factor to be used in analog beamforming, hybrid beamforming, or both, based at least in part on the one or more repetitions of the one or more CSI-RSs.

Aspect 9: The method of aspect 8, further comprising: determining the beam weight factor based at least in part on a weighted combination of a set of beam weight vectors associated with the one or more repetitions of the one or more CSI-RSs.

Aspect 10: The method of any of aspects 8 through 9, further comprising: receiving, from the base station, an indication that the UE is to perform a full beam sweep or a partial beam sweep across beams of the indicated set of TCI states; and determining the beam weight factor based on a weighted combination of beam weights of the full beam sweep or the partial beam sweep.

Aspect 11: The method of any of aspects 1 through 10, wherein the two or more beams comprise a different number of beams for different CRIs.

Aspect 12: A method for wireless communication at a base station, comprising: transmitting, to a UE, an indication that a CSI-RS resource indicator is associated with two or more beams; transmitting, to the UE, a downlink burst comprising one or more CSI-RSs for measurement by the UE in accordance with the CRI; and receiving, from the UE, one or more CSI reports for the two or more beams based at least in part on the measurement.

Aspect 13: The method of aspect 12, further comprising: transmitting, to the UE, a downlink transmission over a weighted combination of the two or more beams in accordance with the one or more CSI reports.

Aspect 14: The method of any of aspects 12 through 13, wherein the monitoring further comprises: receiving, from the UE, the one or more CSI reports comprising a measured RSRP for each of the two or more beams indicated by the CRI.

Aspect 15: The method of aspect 14, further comprising: receiving, from the UE, an indication of the two or more beams associated with the CRI, the two or more beams having a RSRP that exceeds a threshold RSRP for measurements of the one or more CSI-RSs.

Aspect 16: The method of any of aspects 14 through 15, wherein the two or more beams comprise a total number of beams in a channel having a RSRP that exceeds the threshold.

Aspect 17: The method of any of aspects 12 through 16, further comprising: transmitting, to the UE, a set of TCI states associated with the two or more beams.

Aspect 18: The method of aspect 17, wherein each TCI state of the set of TCI states is associated with a beam weight, a set of beam weights, a beam weight set index, or any combination thereof.

Aspect 19: The method of claim 17, further comprising: transmitting, to the UE, a selection of the two or more beams based at least in part on one or more different CSI reports received from at least one other UE.

Aspect 20: The method of any of aspects 12 through 19, further comprising: transmitting, to the UE, an indication of a set of TCI states and a repetition factor associated with the one or more CSI-RSs; transmitting, to the UE, one or more repetitions of the one or more CSI-RSs in accordance with the repetition factor; and receiving, from the UE, a beam having a beam weight factor based at least in part on the one or more repetitions of the one or more CSI-RSs.

Aspect 21: The method of aspect 20, wherein the beam weight factor is based at least in part on a weighted combination of a set of beam weight vectors associated with the one or more repetitions of the one or more CSI-RSs.

Aspect 22: The method of any of aspects 20 through 21, further comprising: transmitting, to the UE, an indication that the UE is to perform a full beam sweep or a partial beam sweep across beams of the indicated set of TCI states.

Aspect 23: The method of any of aspects 12 through 22, wherein the two or more beams comprise a different number of beams for different CRIs.

Aspect 24: An apparatus for wireless communication at a UE, comprising a processor; memory coupled with the processor; and instructions stored in the memory and executable by the processor to cause the apparatus to perform a method of any of aspects 1 through 11.

Aspect 25: An apparatus for wireless communication at a UE, comprising at least one means for performing a method of any of aspects 1 through 11.

Aspect 26: A non-transitory computer-readable medium storing code for wireless communication at a UE, the code comprising instructions executable by a processor to perform a method of any of aspects 1 through 11.

Aspect 27: An apparatus for wireless communication at a base station, comprising a processor; memory coupled with the processor; and instructions stored in the memory and executable by the processor to cause the apparatus to perform a method of any of aspects 12 through 23.

Aspect 28: An apparatus for wireless communication at a base station, comprising at least one means for performing a method of any of aspects 12 through 23.

Aspect 29: A non-transitory computer-readable medium storing code for wireless communication at a base station, the code comprising instructions executable by a processor to perform a method of any of aspects 12 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, an indication that a channel state information reference signal (CSI-RS) resource indicator is associated with two or more beams;
monitoring, from the base station, a downlink burst comprising one or more CSI-RSs for measurement by the UE in accordance with the CSI-RS resource indicator; and
transmitting, to the base station, one or more channel state information reports for the two or more beams based at least in part on the measurement.

2. The method of claim 1, further comprising:
receiving, from the base station, a downlink transmission over a weighted combination of the two or more beams in accordance with the one or more channel state information reports.

3. The method of claim 1, wherein the monitoring further comprises:
measuring a reference signal received power for each of the two or more beams indicated by the CSI-RS resource indicator; and
transmitting, to the base station, the one or more channel state information reports comprising the measured reference signal received power for the two or more beams.

4. The method of claim 3, further comprising:
selecting the two or more beams based at least in part on a threshold reference signal received power for measurements of the one or more CSI-RSs;
transmitting, to the base station, an indication of the two or more beams associated with the CSI-RS resource indicator, the two or more beams having a reference signal received power that exceeds the threshold.

5. The method of claim 4, wherein the two or more beams comprise a total number of beams in a channel having a reference signal received power that exceeds the threshold.

6. The method of claim 1, further comprising:
receiving, from the base station, a set of transmission configuration indicator (TCI) states associated with the two or more beams; and
selecting the two or more beams based at least in part on the set of TCI states.

7. The method of claim 6, wherein each TCI state of the set of TCI states is associated with a beam weight, a set of beam weights, a beam weight set index, or any combination thereof.

8. The method of claim 1, further comprising:
receiving, from the base station, an indication of a set of TCI states and a repetition factor associated with the one or more CSI-RSs;
receiving, from the base station, one or more repetitions of the one or more CSI-RSs in accordance with the repetition factor; and
determining a beam weight factor to be used in analog beamforming, hybrid beamforming, or both, based at least in part on the one or more repetitions of the one or more CSI-RSs.

9. The method of claim 8, further comprising:
determining the beam weight factor based at least in part on a weighted combination of a set of beam weight vectors associated with the one or more repetitions of the one or more CSI-RSs.

10. The method of claim 8, further comprising:
receiving, from the base station, an indication that the UE is to perform a full beam sweep or a partial beam sweep across beams of the indicated set of TCI states; and
determining the beam weight factor based on a weighted combination of beam weights of the full beam sweep or the partial beam sweep.

11. The method of claim 1, wherein the two or more beams comprise a different number of beams for different CSI-RS resource indicators.

12. A method for wireless communications at a base station, comprising:
transmitting, to a user equipment (UE), an indication that a channel state information reference signal (CSI-RS) resource indicator is associated with two or more beams;
transmitting, to the UE, a downlink burst comprising one or more CSI-RSs for measurement by the UE in accordance with the CSI-RS resource indicator; and
receiving, from the UE, one or more channel state information reports for the two or more beams based at least in part on the measurement.

13. The method of claim 12, further comprising:
transmitting, to the UE, a downlink transmission over a weighted combination of the two or more beams in accordance with the one or more channel state information reports.

14. The method of claim 12, wherein the receiving further comprises:
receiving, from the UE, the one or more channel state information reports comprising a measured reference signal received power for each of the two or more beams indicated by the CSI-RS resource indicator.

15. The method of claim 14, further comprising:
receiving, from the UE, an indication of the two or more beams associated with the CSI-RS resource indicator, the two or more beams having a reference signal received power that exceeds a threshold reference signal received power for measurements of the one or more CSI-RSs.

16. The method of claim 15, wherein the two or more beams comprise a total number of beams in a channel having a reference signal received power that exceeds the threshold.

17. The method of claim 12, further comprising:
transmitting, to the UE, a set of transmission configuration indicator (TCI) states associated with the two or more beams.

18. The method of claim 17, wherein each TCI state of the set of TCI states is associated with a beam weight, a set of beam weights, a beam weight set index, or any combination thereof.

19. The method of claim 17, further comprising:
transmitting, to the UE, a selection of the two or more beams based at least in part on one or more different channel state information reports received from at least one other UE.

20. The method of claim 12, further comprising:
transmitting, to the UE, an indication of a set of TCI states and a repetition factor associated with the one or more CSI-RSs;
transmitting, to the UE, one or more repetitions of the one or more CSI-RSs in accordance with the repetition factor; and
receiving, from the UE, a beam having a beam weight factor based at least in part on the one or more repetitions of the one or more CSI-RSs.

21. The method of claim 20, wherein the beam weight factor is based at least in part on a weighted combination of a set of beam weight vectors associated with the one or more repetitions of the one or more CSI-RSs.

22. The method of claim 20, further comprising:
transmitting, to the UE, an indication that the UE is to perform a full beam sweep or a partial beam sweep across beams of the indicated set of TCI states.

23. The method of claim 12, wherein the two or more beams comprise a different number of beams for different CSI-RS resource indicators.

24. An apparatus for wireless communications at a user equipment (UE), comprising:
a processor;
memory in electronic communication with the processor; and
instructions stored in the memory, wherein the instructions are executable by the processor to:
receive, from a base station, an indication that a channel state information reference signal (CSI-RS) resource indicator is associated with two or more beams;
monitor, from the base station, a downlink burst comprising one or more CSI-RSs for measurement by the UE in accordance with the CSI-RS resource indicator; and
transmit, to the base station, one or more channel state information reports for the two or more beams based at least in part on the measurement.

25. The apparatus of claim 24, wherein the instructions executable by the processor comprise instructions executable by the processor to:
receive, from the base station, a downlink transmission over a weighted combination of the two or more beams in accordance with the one or more channel state information reports.

26. The apparatus of claim 24, wherein the instructions executable by the processor comprise instructions executable by the processor to:
measure a reference signal received power for each of the two or more beams indicated by the CSI-RS resource indicator; and
transmit, to the base station, the one or more channel state information reports comprising the measured reference signal received power for the two or more beams.

27. The apparatus of claim 26, wherein the instructions executable by the processor comprise instructions executable by the processor to:
select the two or more beams based at least in part on a threshold reference signal received power for measurements of the one or more CSI-RSs;
transmit, to the base station, an indication of the two or more beams associated with the CSI-RS resource indicator, the two or more beams having a reference signal received power that exceeds the threshold.

28. The apparatus of claim 24, wherein the instructions executable by the processor comprise instructions executable by the processor to:
receive, from the base station, a set of transmission configuration indicator (TCI) states associated with the two or more beams; and
select the two or more beams based at least in part on the set of TCI states.

29. The apparatus of claim 24, wherein the instructions executable by the processor comprise instructions executable by the processor to:
receive, from the base station, an indication of a set of TCI states and a repetition factor associated with the one or more CSI-RSs;
receive, from the base station, one or more repetitions of the one or more CSI-RSs in accordance with the repetition factor; and
determine a beam weight factor to be used in analog beamforming, hybrid beamforming, or both, based at least in part on the one or more repetitions of the one or more CSI-RSs.

30. An apparatus for wireless communications at a base station, comprising:
a processor;
memory in electronic communication with the processor; and
instructions stored in the memory, wherein the instructions are executable by the processor to:
transmit, to a user equipment (UE), an indication that a channel state information reference signal (CSI-RS) resource indicator is associated with two or more beams;
transmit, to the UE, a downlink burst comprising one or more CSI-RSs for measurement by the UE in accordance with the CSI-RS resource indicator; and
receive, from the UE, one or more channel state information reports for the two or more beams based at least in part on the measurement.
